(19) United States
(12) Patent Application Publication
(10) Pub. No.: US 2024/0125640 A1
(43) Pub. Date: Apr. 18, 2024

(54) ELECTRONIC BALANCE

(71) Applicant: A&D COMPANY, LIMITED, Tokyo (JP)

(72) Inventor: Tsutomu ODAGIRI, Saitama (JP)

(21) Appl. No.: 18/376,721

(22) Filed: Oct. 4, 2023

(30) Foreign Application Priority Data
Oct. 13, 2022 (JP) 2022-164455

(51) Int. Cl. G01G 11/08

(52) U.S. Cl. CPC G01G 11/086; G01G 21/22

(57) ABSTRACT

In an electronic balance used for a scale of a weighing unit of a feeder, a wiring member for supplying an electric signal from a control device to a driving source of a feeder unit is provided so as not to adversely affect a weighing pan. A flexible substrate using as the wiring member has one end provided with an electric signal input substrate and has the other end provided with an electric signal output substrate. A U-shaped curved portion is formed near the electric signal output substrate and arranged below a pan boss. The electric signal output substrate is fixed to the pan boss, the electric signal input substrate is fixed to a fixed frame, and the flexible substrate is provided in a case that houses a sensor unit.

### TECHNICAL FIELD

The present invention relates to an electronic balance, and in particular, to an electronic balance suitable for a weighing unit of a feeder, such as a loss-in-weight (weight loss weighing) type feeder.

### BACKGROUND ART

Conventionally, there has been a loss-in-weight method as a method of weighing, and a loss-in-weight type feeder employing this weighing method has been known. The loss-in-weight type feeder generally includes a hopper unit that stores an object to be measured and a feeder unit that discharges the object to be measured, the feeder unit is provided with a rotating member for discharge, for example, a screw, the discharge weight of the object to be measured is weighed by a scale of the weighing unit, and a motor, which is the driving source of the screw, is driven and controlled by a control device so that the discharge amount per unit time becomes constant.

Conventionally, a loss-in-weight type raw material feeding device using a load cell as a scale has been known. In the loss-in-weight type raw material feeding device, the load cell supports a raw material feeder corresponding to the hopper unit and the feeder unit, and the weight of a discharged raw material is calculated by a control device based on a strain amount of the load cell which changes according to a weight change of the raw material, which is the object to be measured, discharged from the raw material feeder by a conveying screw. In the loss-in-weight type raw material feeding device, an electric signal corresponding to the strain amount from the load cell is transmitted to the control device via a cable, and a control signal for controlling the rotation amount of a drive motor of the conveying screw from the control device is transmitted to the drive motor via another cable (Patent Literature 1).

Further, conventionally, a loss-in-weight type feeder illustrated in FIG. 5 using an electronic balance as the scale has also been known. In the loss-in-weight type feeder, a measurement object feeding device 101 including a hopper 102 which is charged with an object to be measured and has a rotating member for discharge and a motor 103 serving as a driving source of the rotating member for discharge corresponding to the feeder unit is installed on a weighing pan 112 of an electronic balance 111. The weight of the object to be measured in the hopper 102 decreasing along with discharge from the hopper 102 is measured by a sensor unit (not illustrated) housed in a case 113 of the electronic balance 111, and the measured value is transmitted to a control device 104. In the loss-in-weight type feeder using the electronic balance 111 as well, the supply of the source power and control signals to the motor 103 is performed via a cable 106 partially attached to a support plate 105 from the control device 104. In FIG. 5, 107 denotes a vibration isolation table on which the electronic balance 111 is placed.

### CITATION LIST

### Patent Literature

Patent Literature 1: Japanese Published Unexamined Patent Application No. 2018-202841

### SUMMARY OF INVENTION

### Technical Problem

As described above, in the conventional loss-in-weight type feeder, necessary electric power and control signals are supplied from the control device 104 via the cable 106 to the motor 103, which is the driving source for discharging the object to be measured such as a raw material from the raw material feeder or the hopper 102 provided in the scale composed of the load cell or the electronic balance 111. The cable 106 is hard and lacks flexibility, so that a force may be applied to the scale due to, for example, contact of the cable 106. In particular, when the scale is the electronic balance 111, an application of the force exerted by the cable 106 to the weighing pan 112 causes a measurement error in micro measurement that requires high precision. If the cable 106 undergoes a change such as linear expansion due to a change in temperature, the force on the weighing pan 112 increases, and the influence on the micro measurement becomes greater, which becomes a large cause of a measurement error.

Accordingly, it is an object of the present invention to provide an electronic balance suitable for a scale of a weighing unit of a feeder, such as a loss-in-weight type feeder, in which measurement errors caused by the cable are eliminated.

### Solution to Problem

In order to achieve the foregoing object, an electronic balance according to the present invention is an electronic balance used for a weighing unit in a feeder composed of a hopper unit that stores an object to be measured, a feeder unit that discharges the object to be measured in the hopper unit and has a driving source whose discharge amount is controlled by a control device, and the weighing unit that weighs a weight of the object to be measured discharged from the hopper unit, the electronic balance including a weighing pan on which the hopper unit and the feeder unit are installed, a sensor unit configured to measure the weight of the object to be measured discharged from the hopper unit, and a case that houses the sensor unit, wherein a flexible wiring member for supplying an electric signal from the control device to the driving source of the feeder unit is provided in the case.

Instead of the conventional configuration in which the hard and less flexible cable is provided outside the scale, the flexible wiring member is provided in the case that houses the sensor unit of the electronic balance, thereby allowing the influence of the wiring member on the weighing pan to be excluded and the measurement error to be eliminated.

As the flexible wiring member, a flexible flat cable or a flexible substrate is desirable, and a flexible substrate is particularly preferable.

Since the flexible substrate is flexible, it is suitable for use within the case that is narrow, provided with many members, and limited in wiring space, and does not hinder the operation of members of the sensor unit.

In order not to cause a measurement error, it is important that the wiring member not only has flexibility but also its vertical displacement does not become an additional load to the electronic balance. For this reason, the loads generated when flexible substrates of various shapes were pressed down from above were measured, and as a result, it has been found that a flexible substrate having a curved portion having a curved shape in a plan view has a small generated load and in particular a flexible substrate having a U-shaped curved portion has the smallest generated load.

Here, a flexible substrate bent so that the side surface shape of FIG. 6A becomes a lateral J shape (hereinafter, referred to as a “J-shaped substrate”), a flexible substrate bent so that the side surface shape of FIG. 6B becomes a Z shape (hereinafter, referred to as a “Z-shaped substrate”), and a flexible substrate bent so that the planar shape of FIG. 6C becomes a U shape and having one end erected as a push-down end (hereinafter, referred to as a “U-shaped substrate”) are selected from among the measured flexible substrates of various shapes as representative ones, and the measurement results of the substrates are illustrated in FIG. 7. Each graph of FIGS. 7A, 7B, and 7C corresponds to each shape of FIGS. 6A, 6B, and 6C described above. Each graph of FIG. 7 illustrates measured values obtained by measuring the loads generated when each substrate was pushed down by 0.1 mm from above up to 1 mm. As is clear from each of the graphs described above, the generated loads were the smallest for the U-shaped substrate of FIG. 6C. A vertical relative displacement of the weighing pan and the members located below the weighing pan in the electronic balance used for the measurement was 0.05 mm at a load of 3 Kg. The generated load per unit length of 0.05 mm was 110 mg/0.05 mm for the J-shaped substrate of FIG. 6A, 21 mg/0.05 mm for the Z-shaped substrate of FIG. 6B, and 18 mg/0.05 mm for the U-shaped substrate of FIG. 6C. The measurement stability of the electronic balance is also important, but the drift was 5 mg/min for the U-shaped substrate, 10 mg/min for the Z-shaped substrate, and 30 mg/min for the J-shaped substrate, and the U-shaped substrate was the most stable.

From the above, the electronic balance according to the present invention is more specifically such that the flexible substrate has one end provided with an electric signal input substrate and has the other end provided with an electric signal output substrate, a curved portion having a curved shape in a plan view is formed at a portion from the one end to the other end, and the electronic balance is provided with a pan boss vertically displaced in conjunction with the weighing pan and a support member having one end side fixed to a fixed frame and having the other end side supporting an electromagnetic force generator, and the curved portion of the flexible substrate is arranged below the pan boss, the electric signal input substrate is fixed to the fixed frame, and the electric signal output substrate is fixed to the pan boss. The curved portion preferably has a U shape.

According to this configuration, by providing the flexible substrate formed with the curved portion, in particular, the U-shaped curved portion, within the case that houses the sensor of the electronic balance as a wiring member, the vertical displacement of the flexible substrate does not become an additional load to the electronic balance, and the influence on the weighing pan can be excluded, and not only is there no measurement error but also a more stable measurement becomes possible.

### Advantageous Effects of Invention

According to the present invention, in the electronic balance used for the scale of the weighing unit of the feeder, the wiring member for supplying the electronic signal from the control device to the driving source of the feeder unit does not adversely affect the weighing pan, and stable, high-precision, and accurate measurement can be performed without measurement errors.

### BRIEF DESCRIPTION OF DRAWINGS

FIG. 1 is a perspective view schematically illustrating an embodiment of an electronic balance according to the present invention with a case omitted.

FIG. 2 is an enlarged perspective view of a flexible substrate of the same.

FIG. 3 is an enlarged perspective view illustrating another embodiment of the flexible substrate.

FIG. 4 is a partial cross-sectional perspective view illustrating another embodiment of a wiring structure.

FIG. 5 is a front view of a loss-in-weight type feeder using a conventional electronic balance.

FIGS. 6A, 6B, and 6C are perspective views illustrating shapes of flexible substrates bent into a J-shape, a Z-shape, and a U-shape, respectively compared in load generated by the push-down force.

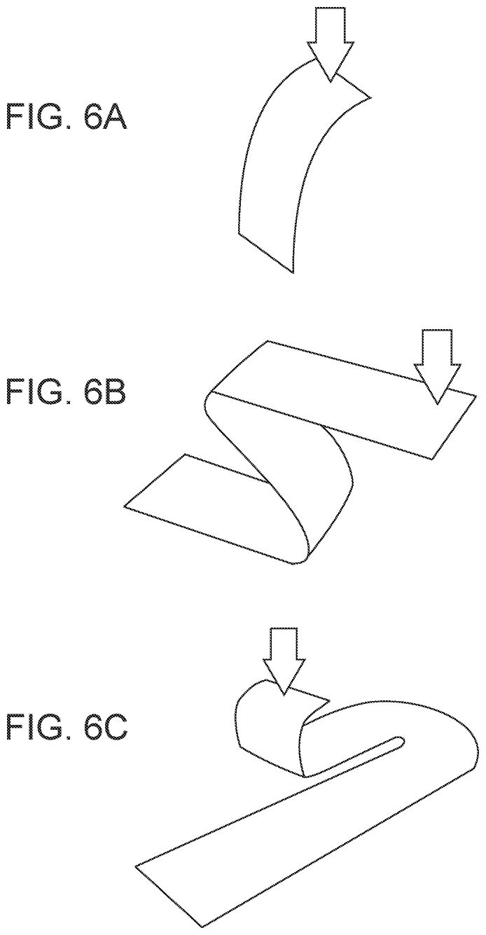

FIGS. 7A, 7B, and 7C are graphs comparing the generated loads in the flexible substrates of respective shapes in FIGS. 6A, 6B, and 6C.

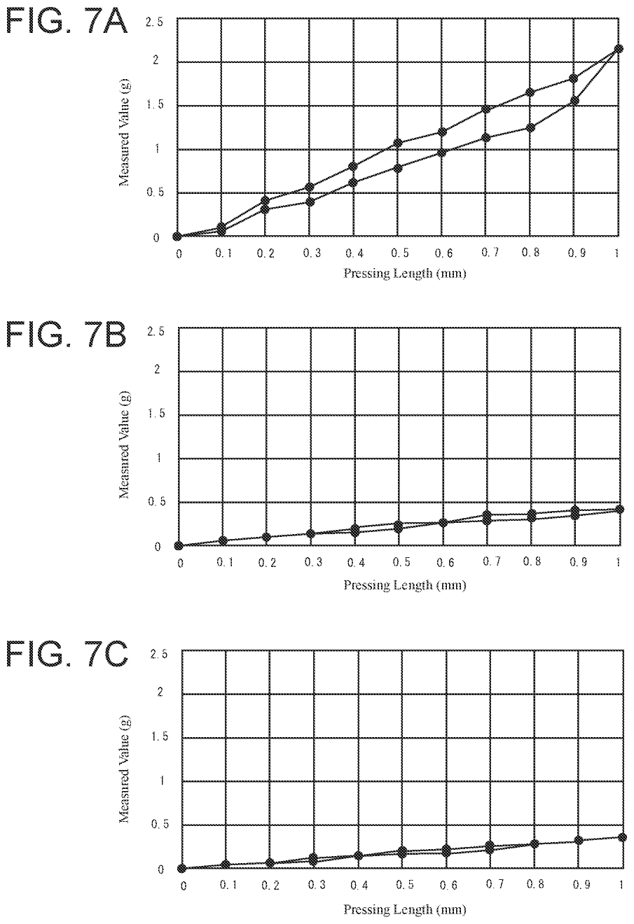

### DESCRIPTION OF EMBODIMENTS

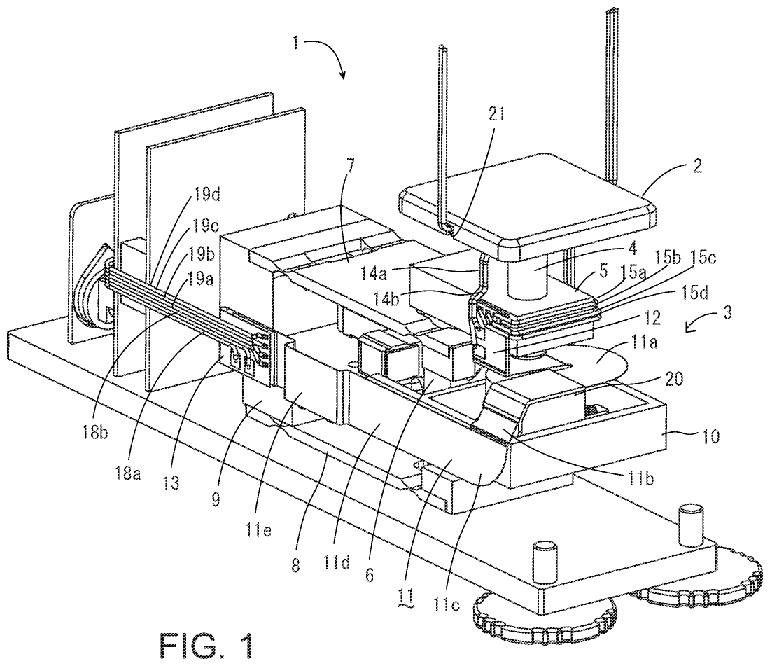

Hereinafter, a preferred embodiment of the present invention will be described with reference to FIG. 1 of the accompanying drawings.

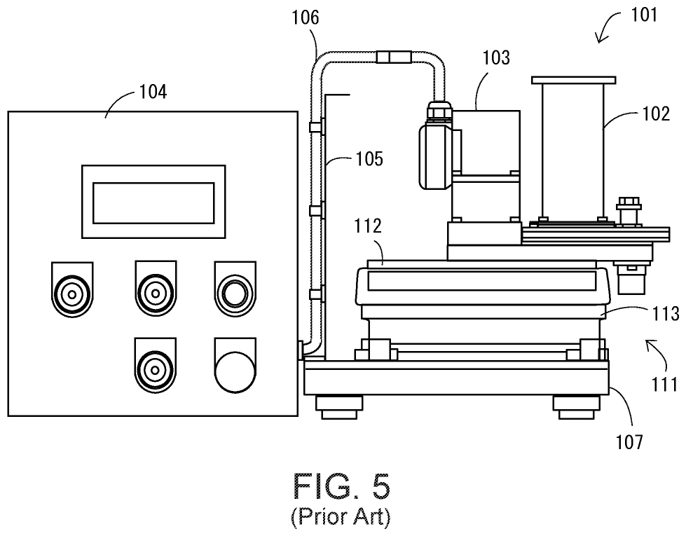

An electronic balance 1 illustrated in FIG. 1 is an electronic balance used as a scale of a weighing unit in a loss-in-weight type feeder, and a measurement object feeding device (not illustrated) is installed on a weighing pan 2. The measurement object feeding device may have a general configuration similar to that of the measurement object feeding device 101 illustrated in FIG. 5, and for example, includes a hopper unit that stores the object to be measured and a feeder unit that discharges the object to be measured in the hopper unit and has a driving source such as a motor whose discharge amount is controlled by a control device, and the weight of the object to be measured discharged from the hopper unit is weighed by a sensor unit 3 of the electronic balance 1. The sensor unit 3 is housed in a case similar to the case 113 illustrated in FIG. 5, but the illustration of the case is omitted.

Next, the sensor unit 3 will be described, but the sensor unit 3 has basically the same configuration as a general electromagnetic balance sensor unit. A lifting shaft 4 to which the weighing pan 2 is attached is supported by a pan boss 5, and the pan boss 5 is fixed to an upper portion of a floating frame 6. The floating frame 6 has upper and lower ends fixed to one-end portions of an upper stay 7 and a lower stay 8 of a Roberval mechanism. Each stay 7, 8 has the other end portion to which a fixed frame 9 is fixed, and to the fixed frame 9, one end side of a support frame 10, which is a support member, is fixed. The support frame 10 has the other end side which is a free end, and on the other end side, an electromagnetic force generator 20 is supported. The electromagnetic force generator 20 incorporates a magnetic circuit composed of a magnet, etc., and a coil arranged so as to be movable up and down although not illustrated, and the coil is provided at a distal end of a lever member (similarly not illustrated).

The lever member is configured to be displaced when a load is applied to the weighing pan 2 and the pan boss 5 descends together with the weighing pan 2, and the coil at the distal end portion of the lever member is configured to rise according to the descending amount of the pan boss 5. A current flowing through the coil is feedback-controlled so as to prevent the coil from rising due to the displacement of the lever member. Here, the larger the load on the weighing pan 2, the larger the value of the current flowing through the coil. Thus, the load on the weighing pan 2, that is, the weight of the object to be measured, can be measured based on the value of the current flowing through the coil.

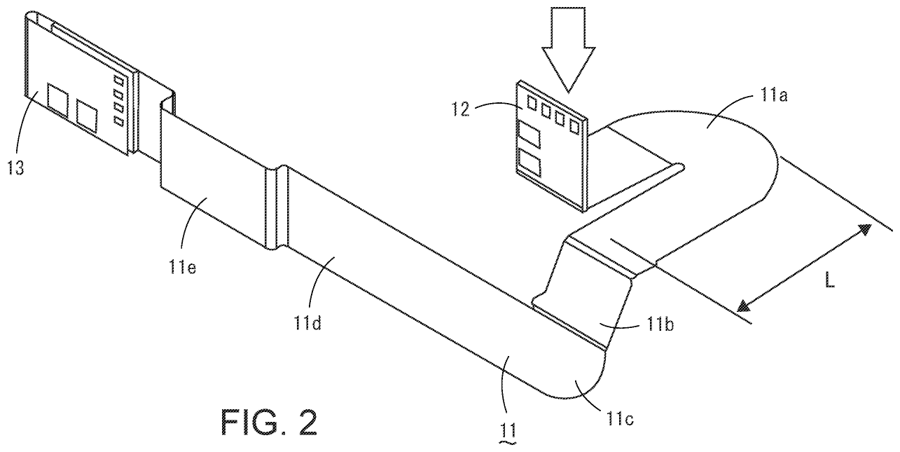

Subsequently, a flexible substrate 11, which is a wiring member, will be described. As illustrated in FIG. 2, the flexible substrate 11 has one end side formed with a U-shaped curved portion 11a having a U shape in a plan view, and the U-shaped curved portion 11a has one end provided with an electric signal output substrate 12 in such a manner as to be vertically erected. The U-shaped curved portion 11a has the other end forming a straight portion 11d extending straight from an inclined portion 11b extending obliquely downward via a curved portion 11c curved at a substantially right angle. The straight portion 11d further goes through a protrusion lie protruding in the thickness direction and in a direction away from the electric signal output substrate 12 and reaches the other end portion, and at the other end portion, an electric signal input substrate 13 is provided. The surfaces of the straight portion 11d and the protrusion lie are positioned perpendicular to the surface of the U-shaped curved portion 11a.

As illustrated in FIG. 1, the U-shaped curved portion 11a of the flexible substrate 11 is arranged below the pan boss 5, the electric signal output substrate 12 is fixed to a side surface of the pan boss 5, and the electric signal input substrate 13 is fixed to a side surface of the fixed frame 9. The protrusion lie is formed in order to avoid interference with members of the sensor unit 3. Since the flexible substrate 11 is flexible, it can be easily deformed according to the configuration of the sensor unit 3.

Flexible power supply output wirings 14a, 14b have one ends and flexible control signal output wirings 15a, 15b, 15c, 15d have one ends, each connected to the electric signal output substrate 12. The power supply output wirings 14a, 14b have the other ends extending upward from the side surface of the pan boss 5 and extending to the outside from a notch 21 in a side surface of the weighing pan 2. The control signal output wirings 15a, 15b, 15c, 15d have the other ends extending upward and extending to the outside from a notch (not illustrated) in a side surface of the weighing pan 2. Each end extending to the outside is connected to a driving source of the feeder unit (not illustrated). A connector may be provided at each of the extending ends, and the extended ends may be connected to the driving source of the feeder unit by the connectors.

On the other hand, flexible power supply input wirings 18a, 18b have one ends and flexible control signal input wirings 19a, 19b, 19c, 19d have one ends, each connected to the electric signal input substrate 13. The power supply input wirings 18a, 18b have the other ends and the control signal input wirings 19a, 19b, 19c, 19d have the other ends, each extending horizontally, extending outside the case, and connected to a signal output unit of the control device (not illustrated). Although similarly not illustrated, the measurement value of the measurement object measured by the sensor unit 3 is input to the control device as an electric signal.

In the foregoing configuration, when the weight of the object to be measured is measured, the pan boss 5 descends together with the weighing pan 2 according to the load applied to the weighing pan 2, a force is applied to the electric signal output substrate 12 end of the flexible substrate 11 in an arrow direction illustrated in FIG. 2, and the flexible substrate 11 is displaced in the same direction. However, the force is received by the U-shaped curved portion 11a as a minute angle deformation of the length 2L to reduce the generated load due to the deformation. Therefore, the displacement of the flexible substrate 11 does not affect the measurement of the sensor unit 3, and accurate measurement is performed without causing measurement errors.

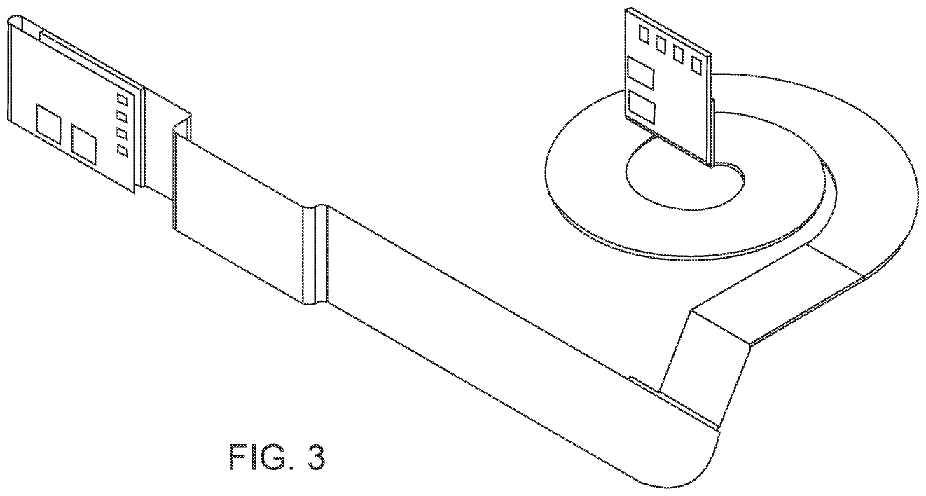

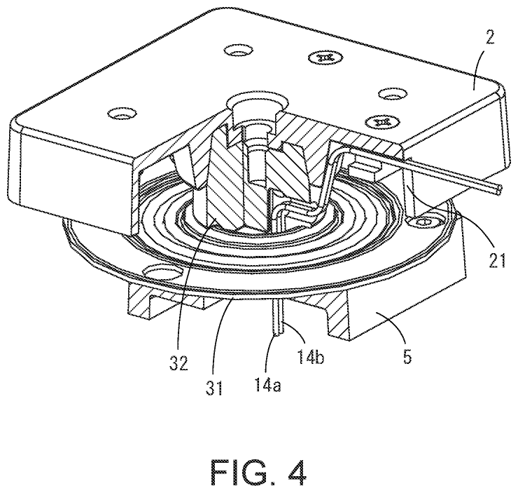

The present invention is not limited to the foregoing embodiment. For example, the curved portion of the flexible substrate 11 may have a spiral shape as illustrated in FIG. 3. When a waterproof structure is required, as illustrated in FIG. 4, a waterproof structure with a diaphragm 31 and a bushing 32 is provided on an upper surface side of the pan boss 5, and the power supply output wirings 14a, 14b and the control signal output wirings (not illustrated) only need to be laid so as to reach the weighing pan 2 through the inside of the pan boss 5.

Further, the electric signal output substrate 12 may be fixed to a member other than the pan boss 5, and the electric signal input substrate 13 may be fixed to a member other than the fixed frame 9. These fixing members are appropriately selected according to the configuration of the sensor unit 3, and the configuration of the sensor unit 3 is not limited to the foregoing embodiment.

### REFERENCE SIGNS LIST

1 Electronic balance
2 Weighing pan
3 Sensor unit
4 Lifting shaft
5 Pan boss
6 Floating frame
7 Upper stay
8 Lower stay
9 Fixed frame
10 Support frame
11 Flexible substrate
11a U-shaped curved portion
12 Electric signal output substrate
13 Electric signal input substrate
14a, 14b Power supply output wiring
15a, 15b, 15c, 15d Control signal output wiring
18a, 18b Power supply input wiring
19a, 19b, 19c, 19d Control signal input wiring
20 Electromagnetic force generator

1. An electronic balance used for a weighing unit in a feeder composed of a hopper unit that stores an object to be measured, a feeder unit that discharges the object to be measured in the hopper unit and has a driving source whose discharge amount is controlled by a control device, and the weighing unit that weighs a weight of the object to be measured discharged from the hopper unit, the electronic balance comprising:
a weighing pan on which the hopper unit and the feeder unit are installed;
a sensor unit configured to measure the weight of the object to be measured discharged from the hopper unit; and
a case that houses the sensor unit, wherein
a flexible wiring member for supplying an electric signal from the control device to the driving source of the feeder unit is provided in the case.

2. The electronic balance according to claim 1, wherein the wiring member is a flexible substrate.

3. The electronic balance according to claim 2, wherein the flexible substrate has one end provided with an electric signal input substrate for inputting an electric signal from the control device and has the other end provided with an electric signal output substrate for outputting an electric signal to the driving source of the feeder unit, a curved portion having a curved shape in a plan view is formed at a portion from the one end to the other end, and the electronic balance is provided with a pan boss vertically displaced in conjunction with the weighing pan and a support member having one end side fixed to a fixed frame and having the other end side supporting an electromagnetic force generator, and
the curved portion of the flexible substrate is arranged below the pan boss, the electric signal input substrate is fixed to the fixed frame, and the electric signal output substrate is fixed to the pan boss.

4. The electronic balance according to claim 3, wherein the curved portion has a U shape.
